(19) United States
(12) Patent Application Publication
(10) Pub. No.: US 2010/0287349 A1
(43) Pub. Date: Nov. 11, 2010

(54) INFORMATION STORAGE PROTECTOR

(76) Inventors: Li-Kuo Chiu, Taipei City (TW); I-Chung Liao, Taipei City (TW)

Correspondence Address: Guice Patents PLLC, 12647 Galveston Court #302, Manassas, VA, 20112, US

(21) Appl. No.: 12/437,048

(22) Filed: May 7, 2009

(51) Int. Cl. G06F 12/14; G06K 9/00; G06F 7/04; G06F 21/00

(52) U.S. Cl. 711/163; 382/124; 726/28; 711/102; 713/186; 711/E12.092; 713/193

(57) ABSTRACT

The present invention relates to an information storage protector that comprises:
a memory device with a memory interface mounted at its front end; wherein, the memory device is mounted a data storage block and a hidden block,a reader linked to a host computer; wherein, the reader is mounted a fingerprint sensor and characteristic authentication processing unit while the interior of hidden block in the memory device is stored the characteristic data of fingerprint from a plurality of users that allows the user to proceed the reading/writing data from/in the memory device provided that the user is recognized by the fingerprint sensor and the characteristic authentication processing unit; and a read & write control software installed in the interior of the abovementioned host computer; wherein, to store the data in the memory device can be proceeded only through the read & write control software.

Thus the demand for the user to use and operate the secret-secured data and the memory device to have a higher level of privacy is achievable.

### BACKGROUND OF THE INVENTION

1. Field of the Invention

The present invention relates generally to a protector, and more particularly to an information storage protector.

2. Description of the Prior Art

Everybody nowadays can not live without the computers and internet that's why everybody wants to store his/her confidential information; such as personal financial details, banking accounting numbers & passwords, private documents and photos, letters of emotion, commercial documentations and intelligent inventions, etc.; in the computer little by little and take the advantage of internet to transmit these information. However, once the computer is stolen or the information stored in the computer is transmitted around the internet without any protection, a threat of exposure or theft against our private information is in front of us. It is reported that approximately one million sets of computer are stolen worldwide every year that creates a loss up to several billion of greenback due to the leakage of confidential information therein. For businessmen and PC users, to protect them from the loss of money and reputation plus the lawful responsibility caused by a disclosure of secrets from their stolen computer or an illegal access to their computer is an extremely urgent demand.

Although most of the people deeply realize that the security protection of information is important; yet there is no any set of simple and easy-to-use tool available for them to do so; more over, the software or hardware solutions currently in existence in the market are either complicated for operation and expensive, or lack of extensive scope of application that establishes a difficult threshold for the user.

In view of the aforementioned situation from the prior art, the inventor of the present invention proposes an information storage protector at length mainly focusing on improving the said imperfection existing in the prior art.

### DETAILED DESCRIPTION OF THE INVENTION

The primary objective of the present invention is to provide an information storage protector; wherein, a read & write control software thereof is used to perform a reading or writing action to a memory device through a reader with the number of time of read & write to write information in the interior of memory device controlled and stored in a hidden block where the operating system of the host computer has no way of becoming aware of this hidden block; and all the information of user will be encrypted for protection while the information of user can only be shown up in the terminal host computer provided that the user ID for the software has been recognized so that the effectiveness of maintaining the secrecy of information is achievable.

Another objective of the present invention is to provide an information storage protector; wherein, a reader equipped with an insertion slot and a memory is taken to link with a host computer; meanwhile, the reader is mounted a fingerprint sensor and a characteristic authentication processing unit while a controller in the reader is able to simulate the memory as a CD-ROM drive and download a read & write control software in the memory; thus, with the reader linked to the host computer, the foregoing read & write control software will be downloaded into the host computer automatically for the user to achieve the objective of use and operation.

One more objective of the present invention is to provide an information storage protector; wherein, thereof reader is mounted a fingerprint sensor and a characteristic authentication processing unit so that the information stored in the block of memory device can be used only if the authentication has been recognized accessible; for instance, the fingerprinted data shall be recognized to match with the fingerprint data stored in the hidden block inside the memory device; following a decryption to the data read from the storage block in the interior of memory device, the information of user will appear in the terminal host computer; thus the demand for a more secure and private system is achievable.

The foregoing objectives of the present invention are attained by an information storage protector that comprises of a memory device with a memory interface fitted at its front end; wherein, the memory device is mounted a data storage block for encryption & storage and a hidden block for encryption & storage; a reader where the memory device can be inserted into its insertion slot; a controller of the reader is able to simulate the memory as a CD-ROM drive and download the aforementioned read & write control software into the memory device; thus, with the reader linked to the host computer, the software in memory will be downloaded into the host computer automatically for the user to use and operate accordingly.

With the host computer linked for operation, a fingerprint sensor and characteristic authentication processing unit (or let the host computer perform the authentication for fingerprint & characteristic identification directly)mounted in the reader will decrypt and read the fingerprint characteristic data of a plurality of users stored in the interior of hidden block in the memory device and allow the user to proceed the decryption, reading & writing data from & in the data block of the memory device provided that the user has been recognized by the fingerprint sensor and the characteristic authentication processing unit; and the foregoing read & write control software downloaded in the reader will be installed in the host computer automatically so that the computer can use this read & write control software to undertake the data storage to the memory device with the number of time of read & write controlled; thus the memory device can be bettered for its privacy to meet the demand from the public in the future.

A detailed description of preferred embodiments set forth below in conjunction with the accompanying drawings thereon are provided for a complete and better understanding of the present invention with respect to thereof objectives, technical descriptions, features and achieved performance.

### BRIEF DESCRIPTION OF THE FIGURES

FIG. 1 is a schematic view in three-dimension of the information storage protector for the present invention.

FIG. 2 is a schematic block diagram of the information storage protector for the present invention.

### REPRESENTATIVE FIGURES DESIGNATED TO THE PRESENT INVENTION

(I) The representative figure designated to the present invention is: the Figure (1).
(II) Elements and thereof reference numbers shown in the representative figure are as follows:
10 Host compute
101 Transmission cable
12 Reader
14 Insertion slot
16 Fingerprint sensor and characteristic authentication processing unit
20 Memory device
22 Memory interface
24 Hidden block
26 Data storage block

### DESCRIPTION OF REFERENCE NUMBERS FOR MAJOR ELEMENTS

10 Host computer
101 Transmission cable
12 Reader
13 Memory
14 Insertion slot
15 Controller
16 Fingerprint sensor and characteristic authentication processing unit
17 Fingerprint authentication engine
18 Fingerprint comparison engine
19 Encryption & decryption engine
19′ Encryption & decryption engine
20 Memory device
22 Memory interface
24 Hidden block
26 Data storage block
30 Read & write control software

### DETAILED DESCRIPTION OF THE PREFERRED EMBODIMENTS

A detailed description of the preferred embodiments in conjunction with the accompanying figures thereon for the present invention are provided below for the Examiner to conveniently and concisely understand other featured contents and advantages of the present invention together with the obviousness of thereof achieved performance:

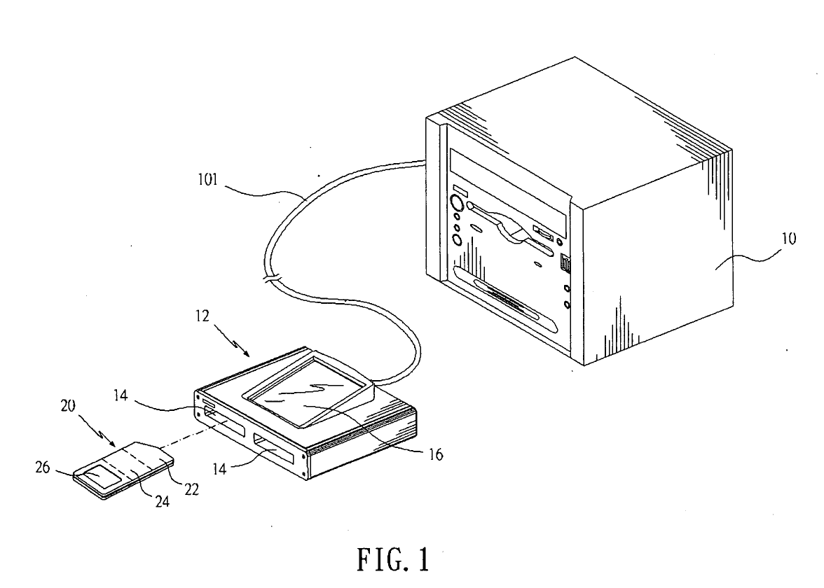

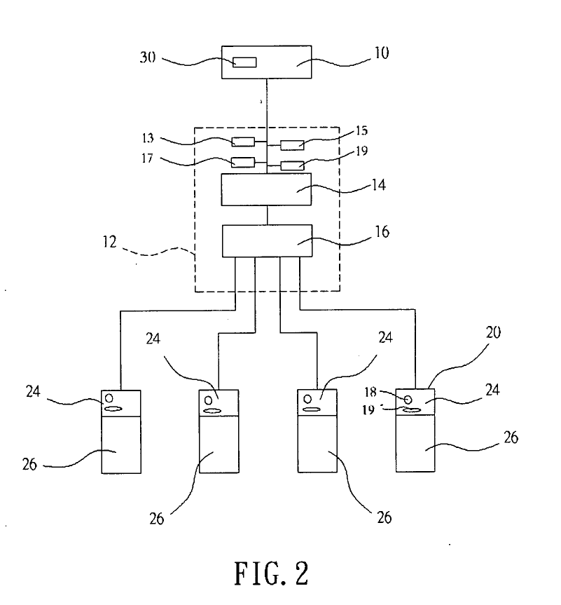

Referring to the FIG. 1 for a schematic view in three-dimension of the information storage protector for the present invention and the FIG. 2 for a schematic block diagram of the information storage protector for the present invention, the present invention as shown in the figures comprises of a host computer 10 and a reader 12; wherein, the host computer 10 and the reader 12 can be linked through a transmission cable 101 so that the data can be transmitted between the reader 12 and the host computer 10; also, the reader 12 is fitted a plurality of insertion slots 14, a fingerprint sensor and a fingerprint characteristic authentication processing unit that provides a convenience for directly capturing the fingerprint characteristic data of user, or let the host computer 10 undertake the capture of fingerprint characteristic data directly; a memory 13 is built in the reader 12; a controller 15 of the reader will simulate this memory 13 as a CD-ROM drive and download a read & write control software 30 in it; thus, with the reader 12 linked to the host computer 10, the read & write control software will be downloaded into the host computer 10 automatically for the user to achieve the objective of use and operation.

A memory device 20; wherein, the front end of the memory device 20 is mounted a memory interface 22 with a hidden block 24 and a data storage block 26 built in while the hidden block 24 is stored a plurality of entries of user's fingerprint characteristic data; thus the host computer is cleared to perform the action of reading and accessing the data from the data storage block 26 inside the memory device 20 through the reader 12 provided that the user has been recognized by the fingerprint sensor and fingerprint characteristic authentication processing unit 16 or the computer is enabled to perform the fingerprint characteristic authentication directly.

The host computer 10 has a standard communication interface (variety of standard communication interfaces, such as USB, 1394, etc.)(not shown in the figure); wherein, the interface (not shown in the figure) can be linked to the reader 12 for the host computer 10 to download a read & write control software 30 into the reader 12; and the action of embedding or reading the data from the memory device 20 is doable provided that the read & write control software 30 is activated; meanwhile, the software is able to limit the number of time of writing action against the memory device 20 as well with this limited condition written into the interior of the abovementioned hidden block 24; hence, using the read & write control software 30 to write the data in the interior of memory device 20 can be performable only after the fingerprint characteristic data have been recognized through the present invention to further achieve a higher level of security and privacy; consequently, the present invention can replace the conventional memory cards or CD disks used at the present stage that makes the capacity and the security highly promoted.

The memory device 20 can be any standard memory card as a storage device; for example: SD memory card, CF memory card, MS memory card or XD memory card, etc. standard memory cards.

The present invention primarily relates to an information storage protector that comprises of a memory device 20 with a memory interface 22 fitted at its front end; wherein, the memory device 20 is equipped with a data storage block 26 and a hidden block 24; a reader 12 is linked to a host computer 10 while the reader 12 with a fingerprint sensor and characteristic authentication processing unit 16 equipped is able to perform the action of user recognition, or the host computer 10 can execute the fingerprint characteristic authentication directly instead by making a comparison with the fingerprint characteristic data from a plurality of users stored in the interior of hidden block 24; thus, the user is able to read/write data from/in memory device 20 provided that he/she has been recognized by the fingerprint sensor and characteristic authentication processing unit 16.

The present invention, for a further detailed description, is to equip the reader 12 with a fingerprint sensor and characteristic authentication processing unit 16, and then allow the reader 12 to perform the capture of the fingerprint characteristic data, or let the host computer 10 capture the fingerprint characteristic data directly and follow to encrypt and transmit the captured fingerprint characteristic file to the memory device 20 for the controller 15 in the memory device 20 to proceed the decryption together with a comparison made to the fingerprint characteristic data of a plurality of users from the interior of hidden block 24; that is, the action of authentication for the user will be performed in the memory device 20; after that, following a successful recognition, to read/write data from/in the memory device 20 directly is performable that consequently enhances the present invention for thereof security

What is more, the present invention is able to have the reader 12 mounted a fingerprint sensor and characteristic authentication processing unit 16, a fingerprint authentication engine 17 and an encryption/decryption engine 19 that further enhances the security and the performance of the system; on the other hand, the reader 12 will perform the capture of the fingerprint characteristic data, transmit the captured fingerprint characteristic file plus the user-enrolled fingerprint characteristic file read from the hidden block 24 in the memory device 20 to the encryption/decryption engine 19 of reader 12 for proceeding the decryption and importing the files to the fingerprint authentication engine 17 for thereof action of authenticating the currently accessed real-time fingerprint image of user; after that, following a successful recognition, to read/write data from/in the memory device 20 directly is performable that consequently enhances the present invention for thereof security.

Finally, the present invention is able to have the memory device 20 further mounted a fingerprint comparison engine 18 and an encryption/decryption engine 19 that allows the reader 12 or the host computer 10 to perform the capture of the fingerprint characteristic data and then encrypt & transmit the captured fingerprint characteristic file to the memory device 20 for proceeding a decryption together with a comparison made to the fingerprint characteristic data of a plurality of users from the interior of hidden block 24 in the memory device 20; that is, the action of authentication for the user will be performed in the memory device 20; thus, following a successful recognition, to read/write data from/in the memory device 20 directly is performable that enhances the present invention for thereof security.

It is concluded from the foregoing preferred embodiments that the present invention has achieved thereof desired performance for improvement to break through the technical structure of the prior art; meanwhile the present invention is not easy to be had in mind by those people who are familiar with the said workmanship; furthermore, the present invention has not been disclosed prior to its application for patent while thereof possessed novelty and utility are compliant with the requisites of application for an invention of patent; therefore, an application for patent is filed in accordance with the statutes of patent while an approval from your esteem Bureau to this application for the present invention, as an encouragement to an invention, will be highly appreciated.

The foregoing preferred embodiments are simply to describe the technical ideas and features of the present invention while thereof objectives are to allow those people who know the said workmanship very well to understand the contents of the present invention and put them into practice accordingly; therefore, it is intended that the description of the preferred embodiments for the present invention illustrates rather than limits the present invention; that is, all the simply equivalent changes and modifications made to the spirits disclosed in the present invention shall be resided within the scope of patent set forth below for the present invention.

What is claimed is:

1. An information storage protector, comprising:
a memory device with a memory interface fitted at its front end; wherein, the memory device is mounted a data storage block and a hidden block,
a reader linked to a host computer; wherein, the reader is mounted a fingerprint sensor and characteristic authentication processing unit while the interior of hidden block in the memory device is stored the characteristic data of fingerprint from a plurality of users that allows the user to proceed the decryption, reading/writing data from/in the memory device provided that the user is recognized by the fingerprint sensor and characteristic authentication processing unit; and
a read & write control software installed in the interior of the abovementioned host computer; wherein, to store the data in the memory device can be proceeded only through the read & write control software.

2. An information storage protector as claimed in the claim 1; wherein, the memory device is a memory storage chip.

3. An information storage protector as claimed in the claim 2; wherein, the memory storage chip is a SD memory card, CF memory card, MS memory card or XD memory card, etc., variety of standard memory cards.

4. An information storage protector as claimed in the claim 1; wherein, the read & write control software is able to control the memory device for its number of time of read & write and embed it in the hidden block.

5. An information storage protector as claimed in the claim 1; wherein, the reader is built in a memory and a controller while the controller will simulate the memory as a CD-ROM drive and install the abovementioned read & write control software in it when the host compute performs the capture of the fingerprint characteristic data directly; thus, with the reader linked to the host computer, the foregoing software will be downloaded into the host computer automatically for the user to use and operate accordingly.

6. An information storage protector as claimed in the claim 1; wherein, the reader is further mounted a fingerprint authentication engine and an encryption/decryption engine that allows the reader to perform the capture of the fingerprint characteristic data directly, transmit the captured fingerprint characteristic file plus the user-enrolled fingerprint characteristic file read from the hidden block in the memory device to the encryption/decryption engine of reader for proceeding the decryption and importing the files to the fingerprint authentication engine for thereof action to authenticate the real-time fingerprint image of user captured thereon; after that, following a successful recognition, to read/write data from/in the memory device directly is performable.

7. An information storage protector as claimed in the claim 1; wherein, the memory device is further mounted a fingerprint comparison engine and an encryption/decryption engine that allows the reader or the host computer to perform the capture of the fingerprint characteristic data, and then encrypt and transmit the captured fingerprint characteristic file to the memory device for proceeding a decryption together with a comparison made to the fingerprint characteristic data of a plurality of users from the interior of hidden block in the memory device; after that, following a successful recognition, to read/write data from/in the memory device directly is performable.
